(19) United States
(12) Patent Application Publication
(10) Pub. No.: US 2024/0182794 A1
(43) Pub. Date: Jun. 6, 2024

(54) Process and plant for improving gasoline yield and octane number

(71) Applicant: Topsoe A/S, Kgs. Lyngby (DK)

(72) Inventors: Finn JOENSEN, Hørsholm (DK); Arne Knudsen, Copenhagen Ø (DK); Mathias Jørgensen, Hillerød (DK); John Bøgild Hansen, Humlebaek (DK)

(73) Assignee: Topsoe A/S, Kgs. Lyngby (DK)

(21) Appl. No.: 18/286,201

(22) PCT Filed: Apr. 20, 2022
(86) PCT No.: PCT/EP2022/060364

§ 371 Date: Oct. 9, 2023

(30) Foreign Application Priority Data
Apr. 20, 2021 (EP) 21169304.9

(51) Int. Cl. C10G 3/00; B01D 3/14; B01J 8/04; B01J 29/40

(52) U.S. Cl. CPC C10G 3/54; B01D 3/14; B01J 8/0492; B01J 29/405; C10G 3/49; C10G 2400/02

(57) ABSTRACT

Process and plant for producing a gasoline product from an oxygenate feed stream comprising the steps of: conducting the oxygenate feed stream to an oxygenate-to-gasoline reactor, suitably a methanol-to-gasoline (MTG) reactor, under the presence of a fixed bed of catalyst active for converting oxygenates in the oxygenate feed stream to a raw gasoline stream comprising C3-C4 paraffins and C5+ hydrocarbons; separating from the raw gasoline stream a gasoline product stream comprising the C5+ hydrocarbons and a stream comprising C3-C4 paraffins; conducting the entire stream comprising C3-C4 paraffins or a portion thereof to an upgrading reactor under the presence of a catalyst active for converting the C3-C4 paraffins into an aromatic stream such as an aromatic stream comprising benzene, toluene and xylene (BTX); and combining the entire aromatic stream or a portion thereof with the oxygenate feed stream.

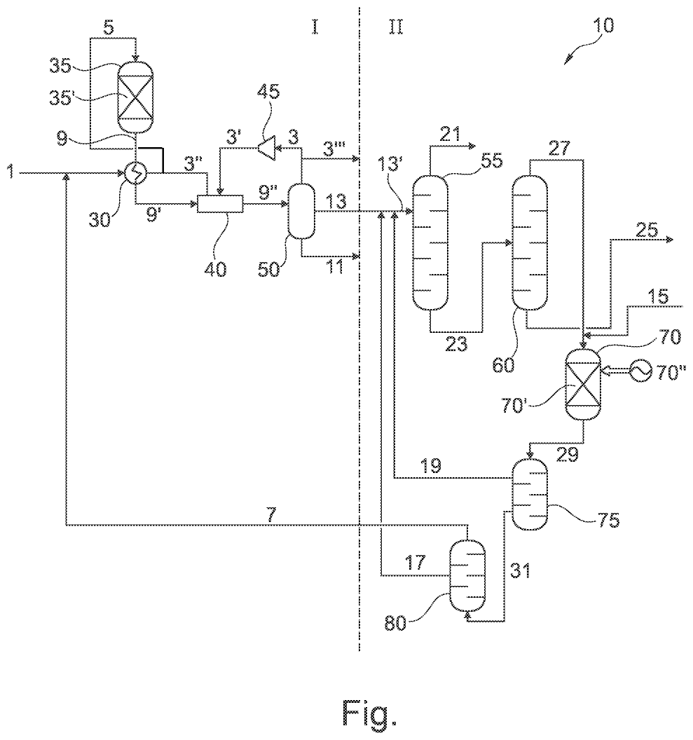

### TECHNICAL FIELD

The present invention relates to a process and plant for converting an oxygenate feed stream such as e-methanol into a gasoline product including the use of a methanol-to-gasoline (MTG) reactor, and in which C3-C4 compounds, e.g. as liquified petroleum gas (LPG), formed during the oxygenate conversion, are separated and upgraded to aromatic compounds in an upgrading reactor for thereby increasing the yield and octane number of the gasoline product. Embodiments of the invention include separation of a benzene-rich fraction from the aromatic compounds which is then combined with the oxygenate stream fed to the MTG reactor. Embodiments of the invention include also the upgrading being conducted in an electrically heated reactor (e-reactor), without separate addition of oxygenates to the upgrading reactor.

### BACKGROUND

The known technology for gasoline synthesis from oxygenates such as methanol involves plants comprising a MTG section (methanol-to-gasoline section) and a downstream distillation section. The MTG section may also be referred as MTG loop and comprises: a MTG reactor; a product separator for withdrawing a bottom water stream, an overhead recycle stream from which an optional fuel gas stream may be derived, as well as a raw gasoline stream comprising C2 compounds, C3-C4 paraffins (LPG) and C5+ hydrocarbons (gasoline boiling components); and a recycle compressor for recycling the overhead recycle stream by combining it with the oxygenate feed stream, e.g. methanol feed stream. The overhead recycle stream (or simply, recycle stream) acts as diluent, thereby reducing the exothermicity of the oxygenate conversion. In the distillation section, C2 compounds are removed in a de-ethanizer, such as de-ethanizer column, and then a C3-C4 fraction is removed as LPG as the overhead stream in a LPG-splitting column (LPG splitter), while stabilized gasoline is withdrawn as the bottoms product. The stabilized gasoline or the heavier components of the stabilized gasoline, such as the C9-C11 fraction, may optionally be further treated and thereby refined, e.g. by conducting hydroisomerization (HDI) into an upgraded gasoline product.

During the gasoline synthesis according to the well-established and commercially available MTG technology, catalyst lifetime and octane numbers decline slowly but steadily, because selectivity to aromatics decreases. The standard solution to maintain the octane number would be to operate the gasoline synthesis at more severe conditions. This compromises gasoline yields and catalyst longevity.

It is also known to convert LPG to aromatic compounds.

CN 104447157 discloses a process for preparing an aromatic hydrocarbon mixture rich in benzene, methylbenzene and xylene from methanol through light olefins.

CN 104496743 discloses a method of preparing aromatic hydrocarbon mixture rich in benzene, toluene and xylene (BTX) by conversion of methanol to light olefins in fixed bed reactor.

U.S. Pat. No. 4,709,113 A discloses a MTG reactor using a catalyst which converts the oxygenates in the feed to a raw gasoline stream, separating from the raw gasoline stream a gasoline product comprising C5+ hydrocarbons, a stream comprising C3-C4 paraffins and a C2-hydrocarbon stream.

Applicant's EP 2036970 A2 discloses a process for the preparation of hydrocarbon products including the steps of: mixing an oxygenate stream with a recycle stream to form a gasoline feed stream which is contacted with a gasoline synthesis catalysts, thereby producing an effluent stream with higher hydrocarbons boiling in the gasoline range; and splitting a part of the effluent stream to form the recycle stream which is optionally further reduced in content of water or enriched in hydrogen, then pressurized and recycled to the mixing step.

Applicant's WO 20018007484 discloses a MTG reactor with a zeolitic catalyst having a MFI framework such as Zn-exchanged or impregnated H-ZSM-5. The catalyst may comprise a phosphorous compound.

US 20200231880 (WO 200150053 A1) discloses a method for conversion of an oxygenate feed to gasoline, separating a light paraffin stream comprising C3-C4 paraffins and a stream comprising C5+ hydrocarbons from the conversion effluent; and exposing at least a portion of the light paraffin stream together with an oxygenate co-feed to a second conversion to form an upgraded effluent comprising aromatics.

### SUMMARY

It is an object of the present invention to provide a process and plant for producing a gasoline product from oxygenates with further integration of an upgrading reactor for converting C3-C4 to aromatics in the distillation section with the upstream MTG section, while at the same time increasing the yield and octane number of the gasoline product.

This and other objects are solved by the present invention.

Accordingly, in a first aspect, the invention is a process for producing a gasoline product from an oxygenate feed stream, the process comprising the steps of:
i) conducting the oxygenate feed stream to an oxygenate-to-gasoline reactor, suitably a methanol-to-gasoline (MTG) reactor, under the presence of a fixed bed of catalyst active for converting oxygenates in the oxygenate feed stream to a raw gasoline stream comprising C3-C4 paraffins and C5+ hydrocarbons;
ii) separating from the raw gasoline stream a gasoline product stream comprising the C5+ hydrocarbons and a stream comprising C3-C4 paraffins;
iii) conducting the entire stream comprising C3-C4 paraffins or a portion thereof to an upgrading reactor under the presence of a catalyst active for converting the C3-C4 paraffins into an aromatic stream comprising any of benzene, toluene or xylene, or combinations thereof, such as an aromatic stream comprising benzene, toluene and xylene (BTX);
iv) combining the entire aromatic stream or a portion thereof with the oxygenate feed stream, i.e. the oxygenate feed stream of step i);
and wherein step iii) does not comprise co-feeding an oxygenate stream to the upgrading reactor.

As used herein, the term “C3-C4 paraffins” is also referred to as “LPG”. The term “LPG” means liquid/liquified petroleum gas, which is a gas mixture mainly comprising propane and butane, i.e. C3-C4; LPG may also comprise i-C4 and a minor portion of olefins.

As used herein, the term “integration” means that: a number of the unit operations pertaining to a stand-alone upgrading reactor in the distillation section are already available in the MTG loop; and/or that process conditions, particularly pressure, in the upgrading reactor correspond to process conditions in the MTG loop; and/or there is a reduction of equipment size and energy consumption figures in the MTG loop by adapting the upgrading reactor in the distillation section. More generally, the term “integration” means providing synergy of the MTG loop (MTG section) and distillation section of the process and plant.

As used herein, the octane number is the Research Octane Number, RON, measured according to ASTM D-2699.

As used herein, the term “comprising” may also include “comprising only” i.e. “consisting of”.

As used herein, the term “suitably” is used interchangeably with the term “optionally” and thus may be given the meaning of: a particular embodiment.

The MTG process for producing gasoline is well-known, as for instance disclosed in U.S. Pat. Nos. 4,788,369, 4,481,305 or 4,520,216. During the production of gasoline by the well-known MTG process, the LPG fraction typically constitutes between 15 and 20 wt % of the gasoline product slate. LPG has normally a low value and in the MTG process the value is even lower, because it is very far from specifications, for instance also by the presence of up to about 10 wt % olefins. The gasoline product (C5+ hydrocarbons) is a complex hydrocarbon mixture, comprising e.g. C5-C10 hydrocarbons, and it is known that aromatics contribute to a higher octane number of the gasoline product.

By the present invention, low value LPG is utilized to improve gasoline product yield and octane number. The LPG fraction of the raw gasoline is processed in an upgrading reactor for thereby converting the LPG fraction to almost exclusively BTX (other compounds are also formed e.g. light paraffins and olefins), thereby providing a path for significantly improving gasoline product yield by 5-10% and octane number by 1-3 numbers, while at the same time complying with specifications of aromatic contents in the gasoline product. For instance, the gasoline product yield is increased from 80 to 90% and simultaneously the octane number is increased from about 93 to 94 or 95, which represents a significant, valuable change.

The present invention avoids also the need to resort to conventional upgrading of the LPG fraction of the gasoline product resulting from the use of MTG technology, which normally would require major and costly steps involving hydrogenation and distillation so the LPG is made compliant with standard LPG specifications, and which would also entail significant losses connected to meeting the right C3/C4 balance in the LPG.

Furthermore, by the invention, step iii) does not comprise co-feeding an oxygenate stream to the upgrading reactor. It has been found that while the addition of an oxygenate stream to the upgrading reactor, i.e. co-feeding an oxygenate stream, for instance methanol, would result in its conversion to hydrocarbons; importantly also, water (steam) is produced. This conveys the high risk of steaming the catalyst, in particular a ZSM-5 catalyst being used in the upgrading reactor, which at the high temperatures e.g. 500-650° C. used for its operation, irreversibly deactivates the catalyst. By purposely avoiding the co-feeding of the oxygenate stream, the upgrading reactor is able to operate for longer times, as there is no such catalyst deactivation.

It would be understood, that combining the aromatic stream with the oxygenate feed stream, for instance by co-feeding aromatics to the MTG reactor, is highly counter-intuitive, since it is well-established in the art that undesired formation of coke and coke precursors, as well as methylation and alkylation, take place where aromatics are present together with oxygenates such as methanol and/or dimethyl ether (DME), and olefins. This is believed to have an immediate impact in reducing catalyst cycle length/time in the MTG reactor. The aromatics fed to the MTG reactor are also found in the effluent of the MTG reactor, for instance as methylated aromatic compounds which become part of the raw gasoline stream.

The catalyst cycle time/length is the length of the period where the catalyst exhibits proper catalytic activity. As deactivation by coke formation takes place, the amount of active catalyst available for conversion of oxygenate into gasoline is reduced. It is important to avoid slip of unconverted oxygenates as contents of oxygenates would complicate the separation step for obtaining the gasoline product. After such a cycle time, the catalyst must be regenerated by burning off the coke. Short catalyst cycle time means therefore that an expensive type of reactor must be employed e.g. with continuous regeneration of catalyst circulated between reactor and regenerator, or that several reactors in parallel must be employed with frequent shifts in operation mode (oxygenate conversion or regeneration) and being equipped with complex controls.

By the present invention, combining the aromatic stream containing aromatic compounds such as benzene in the MTG reactor, e.g. by co-feeding aromatics, enables an increase the octane number of the raw gasoline, and thereby in the final gasoline product. While there may be an associated penalty in terms of cycle time reduction in the MTG reactor, this is outweighed by the increase in the octane number, as well as the reduction of inlet temperature to the MTG reactor. It has also namely been found, that combining the aromatics in the MTG reactor according to the present invention, e.g. by co-feeding aromatics, has a similar effect as does co-feeding of higher alcohols, namely that of enabling a reduction in the inlet temperature of the MTG reactor, thereby providing both operational flexibility and extending ultimate catalyst longevity in the MTG reactor. This signifies that the onset of oxygenate conversion, e.g. methanol conversion, starts at a temperature significantly below that corresponding to operation with the oxygenate alone, e.g. no co-feeding of aromatics. Furthermore, the catalyst lifetime in the MTG reactor is extended due to the combined feed thereto (oxygenate and aromatics) becoming more reactive thereby providing more freedom and thus flexibility in the selection of ideal relationship of inlet to outlet temperatures in the MTG reactor.

Suitably, the aromatic stream comprising BTX is a BTX-rich stream. By BTX-rich stream is meant 80 wt % or more BTX, for instance 90, 95 wt % or more BTX.

In an embodiment, the amount of aromatic compounds in the entire aromatic stream comprising BTX with respect to the oxygenate feed stream, e.g. methanol feed stream, entering the MTG reactor, yet prior to any mixing with a recycle stream in the MTG loop, is less than 4 wt %, such as 0.5, 1, 1.5, 2, 2.5, 3, 3.5 wt % of the methanol feed. It has been found that below 4 wt %, the reduction in cycle length is less pronounced. The above amount of below 4 wt % comes on top of the inherent amount of aromatics present in the recycle stream, typically amounting to 1-2 wt % of the methanol feed stream as a result of incomplete separation in the product separator, e.g. high-pressure separator of the MTG loop. For instance, when returning the entire aromatic stream comprising BTX to the MTG reactor, there may be about 5 wt % aromatics in the methanol feed after mixing with the recycle stream, corresponding to 3.5 wt % of BTX and 1.5 wt % inherent amount of aromatics in the recycle stream.

In an embodiment, in step iv, i.e. the step of combining the aromatic stream with oxygenate feed, the portion of the aromatic stream is a benzene-rich stream (B-rich stream) which is separated from the aromatic stream comprising BTX.

By B-rich stream is meant 50 wt % or more benzene, for instance 60, 80, 90, 95 wt % or more benzene.

This further enables easier compliance with gasoline product specifications, which impose ceilings both with respect to aromatic content and benzene content in particular.

It has also been found, that benzene combined with methanol to the MTG reactor, e.g. benzene co-fed along with methanol, becomes extensively methylated by the methanol in the MTG reactor. Thus, benzene, undesired in excessive amounts in the gasoline product, is converted in the MTG reactor forming higher aromatics, such as toluene, xylenes, tri- and tetramethylbenzenes. Therefore, there is no substantial altering of the methylation index, denoting how many methyl groups, on average, are attached to the aromatic rings and which is the determining factor for how much durene (1,2,4,5-tetramethylbenzene)—which is undesired in the raw gasoline and further downstream in the gasoline product—will be in the aromatics fraction provided equilibrium is established with respect to transalkylation and isomerization.

In an embodiment, the amount of the benzene-rich stream with respect to the oxygenate feed stream, e.g. methanol, entering the MTG reactor, yet prior to any mixing with a recycle stream, is 0.5-1.5 wt % of the methanol feed, such as 0.6-1.2 wt % of methanol feed. For instance, the benzene-rich stream is suitably about 0.6 wt % of the methanol feed. Again, this amount comes on top of the inherent amount of aromatics present in e.g. methanol, often about 1-2 wt % which results from incomplete separation upstream in the product separator, e.g. high-pressure separator of the MTG loop.

The aromatic stream, here in particular the benzene-rich stream, is thus combined, e.g. co-fed, in predetermined amounts to approach, but not exceed, aromatics and benzene specifications in the gasoline product while improving gasoline product yield and octane number, and at the same time the risk of coking and thereby reduction of cycle length in the MTG reactor, is reduced.

In an embodiment, the catalyst in the MTG reactor is a zeolitic catalyst having an MFI framework such as ZSM-5, for instance ZSM-5 in its hydrogen form (HZSM-5) or a Zn-modified ZSM-5 optionally further comprising 1-5 wt % of a phosphorous compound, such as 3 wt % P; and wherein the temperature in the MTG reactor is 280-400° C., the pressure is in the range 15-25 bar abs; and optionally the WHSV is 1-6, such as 1-2, for instance 1.5 or 1.6. Suitably also, the zeolitic catalyst has a SiO₂/Al₂O₃ (silica to alumina) ratio of between 50 and 300. Suitably also, MTG reactor has arranged along its length a fixed bed or a plurality of successive fixed beds comprising the catalyst.

As used herein, the term “MFI structure” means a structure as assigned and maintained by the International Zeolite Association Structure Commission in the Atlas of Zeolite Framework Types, which is at http://www.iza-structure.org/databases/ or for instance also as defined in “Atlas of Zeolite Framework Types”, by Ch. Baerlocher, L. B. McCusker and D. H. Olson, Sixth Revised Edition 2007.

It has been found that when using a phosphorous compound, i.e. P-doped zeolitic catalyst, such as zeolitic catalyst containing 1-3 wt % P, and having a low acidity such as a Si/Al ratio of 280, the zeolitic catalyst is more tolerant to the aromatics being added. Hence, on a relative basis (compared to when only using methanol feed), durene level is not noticeably changed. Furthermore, by operating the MTG reactor adiabatically as well as by reducing space velocity (WHSV) to 1-2, for instance 1.5 or 1.6, corresponding to industrial conditions, it is possible to bring the operation closer to equilibrium and thereby reduce durene content.

In an embodiment, the oxygenate stream is methanol and/or dimethyl ether (DME). In another embodiment, the oxygenate feed stream is e-methanol (electrified methanol), i.e. methanol which is produced from synthesis gas prepared by using (supplying) electricity from renewable sources such as hydropower, wind or solar energy, e.g. eMethanol™. Hence, according to this embodiment the synthesis gas may be prepared by combining air separation, autothermal reforming or partial oxidation, and electrolysis of water, as disclosed in Applicant's WO 2019/020513 A1, or from a synthesis gas produced via electrically heated reforming as for instance disclosed in Applicant's WO 2019/228797. Thereby, an even more sustainable approach for the production of raw gasoline, in particular gasoline product, is achieved. While methanol can be produced from many primary resources (including biomass and waste), in times of low wind and solar electricity costs, the production of eMethanol™ enables a sustainable front-end solution. The synthesis gas, which as is well-known in the art, is a mixture comprising mainly hydrogen and carbon monoxide, for methanol synthesis may also be prepared by combining the use of water (steam) electrolysis in an alkaline or PEM electrolysis unit or a solid oxide electrolysis cell (SOEC) unit, thereby generating hydrogen, and the use of an SOEC unit for thereby generating carbon monoxide from a CO₂-rich stream.

In an embodiment, in step iii), i.e. in the upgrading reactor, the process further comprises adding one or more sulfur compounds to the stream comprising C3-C4 paraffins, and the content of the one or more sulfur compounds, such as H₂S, is 10-1000, such as 10-100 ppmv.

Thereby losses due to conversion of LPG to methane and ethane as well as higher (C9+) aromatics are significantly suppressed. Furthermore, given that LPG may contain minor amounts of olefins, e.g. up to 10 wt % C3/C4-olefins, at the high operating temperatures of the upgrading reactor, for instance 500-600° C., the risk of corrosion of metal parts therein, in particular metal dusting, is also reduced. Furthermore, the LPG fraction is thereby efficiently converted into a BTX product with only minimum formation of higher (C9+) aromatics and with a strongly reduced selectivity to methane in the presence of small amounts of sulfur, such about 50 ppm, e.g. as H₂S.

In an embodiment, in step ii) the separation of the raw gasoline stream into a gasoline product stream comprising the C5+ hydrocarbons and a stream comprising C3-C4 paraffins is conducted in a LPG splitter i.e. a fractionation column such as a distillation column. The C3-C4 paraffins, e.g. LPG, is withdrawn as the overhead stream thereof, while the gasoline product stream is withdrawn as the bottom stream. The LPG splitter is also referred as stabilizer and the gasoline product stream as stabilized gasoline. This stabilized gasoline is optionally upgraded by further increasing its octane number via subsequent isomerization, e.g. hydroisomerization (HDI). Suitably, prior to the HDI step, the stabilized gasoline is conducted to a fractionation column for separating light gasoline as overhead stream, fuel oil as bottom stream and intermediate stream as the stabilized gasoline stream for the HDI step.

The material catalytically active in HDI typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MFI, MEL, MOR, FER, MRE, MWW, AEL, TON and MTT) and a refractory support (such as alumina, silica or titania, or combinations thereof). HDI conditions involve a temperature in the interval 250-400° C., a pressure in the interval 20-150 bar, and a liquid hourly space velocity (LHSV) in the interval 0.5-8.

In an embodiment, the raw gasoline stream comprises C2− compounds, such as methane, ethane, ethene, and the process further comprises: prior to step ii), conducting the raw gasoline stream to a de-ethanizer for generating a fuel gas stream comprising the C2− compounds and optionally a sulfur compound such as H₂S. Where a sulfur compound such as H₂S is present in the fuel gas, this is suitably conducted to the HDI step. Accordingly, in a particular embodiment the gasoline product stream comprising the C5+ hydrocarbons, i.e. from step ii), is conducted to a hydroisomerization (HDI) step, optionally after being conducted to a fractionation step e.g. in a distillation column; the fuel gas stream comprising the C2− compounds comprises a sulfur compound, such as H₂S; and the fuel gas stream is added to the HDI step, suitably by admixing with the gasoline product stream prior to entering the HDI step. The content of C2-compounds in the raw gasoline stream is for instance 10 wt % or less.

By conducting the fuel gas stream comprising a sulfur compound from the de-ethanizer to the HDI step, i.e. to the HDI reactor, the catalyst therein is sulfided without resorting to external sulfur sources. Further integration in the process and plant is thereby achieved. The C2− compounds in the fuel gas stream are suitably withdrawn after the HDI step, for instance by simply arranging a product separator downstream the HDI reactor.

In an embodiment, a stream rich in toluene and optionally xylene (T/X-rich stream), as well as a stream rich in paraffins, isoparaffins and olefins (P/I/O-rich stream) optionally also comprising unconverted LPG lower hydrocarbons and C5+ hydrocarbons, are separated from the aromatic stream comprising BTX, and:
at least one of the T/X-rich stream or a portion thereof and the P/I/O-rich stream or a portion thereof, is added to the raw gasoline stream, suitably prior to conducting the raw gasoline stream to the de-ethanizer; and/or
the P/I/O-rich stream or a portion thereof is added to the MTG reactor.

The more aromatics being combined with the oxygenate feed, e.g. co-fed to the MTG reactor, the more aromatics are present in the MTG reactor effluent and thereby in the raw gasoline stream. Hence, even if the methylation index does not increase, higher aromatics and higher durene levels in the raw gasoline product would result. By diverting the T/X-rich stream to the raw gasoline stream, the durene therein is effectively reduced. The T/X-rich stream is suitably added together with the P/I/O-rich stream, the C5+ components contained herein further reducing the concentration of durene in the gasoline product. Suitably, one or more sulfur compounds, such as H₂S, are also added.

The P/I/O-rich stream or a portion thereof may optionally be returned to the MTG reactor in which at least the olefin compounds contained therein will be partially converted into raw gasoline. The P/I fraction will largely function as a heat sink, due to its relatively high heat capacity, thereby reducing the amount of recycle stream used as diluent and reducing recycle compression energy. Accordingly, olefins are purposely utilized to produce even more C5+ hydrocarbons while at the same time exploiting the rather high heat capacity of the C2-C6 compounds in the P/I-fraction of the P/I/O-rich stream. The P/I/O-rich stream is suitably added to the MTG reactor by for instance combining it with the oxygenate feed stream prior to any mixing with a recycle stream. The P/I/O-rich stream may also be combined with the oxygenate feed stream after the mixing with the recycle stream, for instance immediately upstream the MTG reactor i.e. at the MTG reactor inlet.

By T/X-rich stream is meant 50 wt % or more of T/X, for instance 60, 80, 90, 95 wt % or more T/X.

By P/I/O-rich stream is meant 50 wt % or more of P/I/O, for instance 60, 80, 90, 95 wt % or more P/I/O.

In an embodiment, the catalyst in the upgrading reactor, i.e. in step iii), is a zeolitic catalyst having an MFI framework containing 0.1 to 10 percent by weight of a zinc compound. In a particular embodiment, the zeolitic catalyst is ZSM-5, the zinc compound is metallic and/or oxidic zinc, and optionally the zeolitic catalyst further comprises 1-5 wt % of a phosphorous compound, e.g. 1-5 wt % P.

In another particular embodiment, the zeolitic catalyst is H-ZSM.5 having a silica to alumina ratio of 30-100 such as about 40 and comprises 3-7 wt % Zn such as about 5 wt % Zn.

In the upgrading reactor, C_{2, . . . . ,4,5, . . .} paraffins are converted into a mixture of essentially BTX/olefins and light paraffins.

In an embodiment, the temperature in the upgrading reactor is 500-650° C., and the pressure is in the range 3-25 bar abs; suitably wherein the temperature is 500-550° C. such as about 525° C. and the pressure 15-25 bar abs, such as about 20 bar abs.

Suitably, the weight hour space velocity (WHSV) is 3-6, such as 3.

Suitably also, the upgrading reactor is operated adiabatically.

The conversion of the paraffins in the upgrading reactor is endothermic. High temperatures, as recited above, are therefore required to activate paraffins: the first step is dehydrogenation, producing olefins which subsequently react to form aromatics/olefins/paraffins.

By adding sulfur, the harsh conditions imposed in the upgrading reactor in terms of i.a. the high temperatures, dry conditions i.e. no steam being added or being generated, and olefins as intermediates/product and even present in feed, is counteracted: sulfur provides protective properties with respect to corrosion (materials selection), and its selectivity directing properties, reducing methane and heavy oil formation, as described farther above.

By operating at the lower temperature range, for instance at 525° C., and at the higher pressure range, for instance 15 bar abs, the content of benzene in the BTX mixture is shifted towards a BTX mixture having less benzene. Also, at these elevated pressures, selectivity towards BTX increases, producing essentially BTX+paraffins, and at the same time the content of olefins is reduced i.e. olefin selectivity declines. The olefins formed are low olefins: C2= to C5= (only little C6=+ is formed). Therefore, these olefins may for instance be returned to the distillation section, with the C3=/C4=, eventually, being returned to the upgrading reactor through the LPG splitter. Thus, there will be essentially no olefins in the BTX fraction, hence olefins are not co-fed in the MTG reactor. So, the elevated pressure helps increasing the BTX yield and reduce the coking rate in the upgrading reactor. The olefins may also be returned to the MTG reactor, as recited farther above.

By way of example, the distribution of the BTX mixture is shifted from B:T:X 32:55:13 wt % when operating at low pressure (3 bar abs) and 550° C., to B:T:X 17:50:33 wt % when operating at higher pressure (15 bar abs) and 525° C. Hence, there is a significant reduction of benzene. This is important, since benzene in particular is an issue imposing a limit as to how much BTX can be added to the raw gasoline and thus how much is present in the gasoline product.

Furthermore, by operating the upgrading reactor at higher pressures, for instance at about 20 bar abs, expedient and easy integration with the MTG reactor is enabled, since the MTG reactor normally operates at the same pressure, i.e. at about 20 bar abs.

In an embodiment, the upgrading reactor, i.e. in step iii, is an electrically heated reactor (e-reactor); optionally operated adiabatically and optionally also, operated in once-through mode.

In an e-reactor, electrical resistance is used for generating the heat required for the conversion of the paraffins in the upgrading reactor. In particular, when using the e-reactor, electricity from green (renewable) resources may be utilized, such as from electricity produced by wind power, hydropower, and solar sources, thereby further minimizing the carbon footprint. Hence, by the present invention not only the methanol used as oxygenate in the oxygenate feed stream to the MTG reactor may be produced from renewables sources as e-methanol, but renewable sources are also used for the operation of the upgrading reactor. For a description of how to configure the e-reactor, reference is given to applicant's WO 2019/228797 A1

In a particular embodiment, the e-reactor is operated adiabatically and optionally in once-through mode. Due to the endothermic nature of the conversion, there is a temperature decrease of about 100° C. or less, e.g. 75° C., across the region of the e-reactor comprising the catalyst. For instance, from 600° C. to 525° C., and/or from 525° C. to 450° C. Operation in once-through mode enables high conversion yields, for instance 50-60%, while at the same time avoiding the need for recycling the reactant i.e. C3-C4 paraffins.

In an embodiment, the process further comprises, prior to step iv), i.e. prior to combining the entire aromatic stream comprising BTX or a portion thereof with the oxygenate feed stream to the MTG reactor, conducting the aromatic stream comprising benzene, toluene and xylene (BTX) to a buffer tank i.e. BTX buffer tank. The catalyst in the upgrading reactor may require frequent regeneration. However, by adapting the BTX buffer tank, the fluctuations are leveled out, thereby enabling an aromatics reserve for continuously maintaining aromatics including benzene levels close to the limit according to specifications, e.g. up to about 35 vol % in the gasoline product. Hence, at any time it is ensured that the aromatics “freeboard” with respect to increasing yield and octane is exploited to its maximum. It has been found that except for first few cycles, aromatics are in deficit relative to maximum content according to gasoline specifications (up to the above limit). Given that the increase in octane number of the gasoline product is mainly the result of its aromatics content, the buffer tank enables that the aromatics content is up to the above specifications and thereby the octane number is also continuously maintained at a high level.

In a second aspect, the invention encompasses also a plant, i.e. process plant, for carrying out the process according to any of the above embodiments.

Accordingly, there is also provided a plant for producing a gasoline product from an oxygenate feed stream, comprising a methanol-to-gasoline (MTG) section and a downstream distillation section;
wherein said MTG section (I) comprises: a MTG reactor comprising a fixed bed of catalyst, a product separator and a recycle compressor, thereby converting the oxygenate feed stream to a raw gasoline stream comprising C3-C4 paraffins and C5+ hydrocarbons; wherein said distillation section (II) comprises: a de-ethanizer and a LPG-splitter, thereby converting the raw gasoline stream to said gasoline product, and a stream comprising C3-C4 paraffins;
and wherein said plant further comprises:
   an upgrading reactor comprising a catalyst, such as a fixed bed of catalyst, thereby converting the entire stream comprising C3-C4 paraffins or a portion thereof, to an aromatic stream comprising any of benzene, toluene and xylene (BTX), or combinations thereof, such as an aromatic stream comprising benzene, toluene and xylene; said upgrading reactor being absent of, i.e. without, an inlet for co-feeding an oxygenate stream, such as a conduit directing a stream comprising methanol and/or dimethyl ether (DME);
      a conduit for directing the entire aromatic stream or a portion thereof to said oxygenate feed stream.

More specifically, there is provided a plant for producing a gasoline product from an oxygenate feed stream, comprising a methanol-to-gasoline (MTG) section and a downstream distillation section;
wherein said MTG section (I) comprises:
   a MTG reactor comprising a fixed bed of catalyst active for converting oxygenates in the oxygenate feed stream to a raw gasoline stream comprising C3-C4 paraffins and C5+ hydrocarbons, said MTG reactor comprising an inlet for receiving said oxygenate feed stream and an outlet for withdrawing said raw gasoline stream;
a product separator comprising an inlet for receiving said raw gasoline stream, an outlet for withdrawing an overhead recycle stream, an outlet for withdrawing a bottom water stream, and an outlet for withdrawing a raw gasoline stream comprising C3-C4 paraffins and C5+ hydrocarbons;
a recycle compressor comprising a suction side arranged for receiving said overhead recycle stream and a discharge side arranged for directing the compressed overhead recycle stream to a mixing point where it is combined with the oxygenate feed stream, and then directed to the MTG reactor;
wherein said distillation section (II) comprises:
   a de-ethanizer, suitably a fractionation column, comprising an inlet for receiving said raw gasoline stream from the product separator, an outlet for withdrawing an overhead fuel gas stream comprising C2-compounds, and an outlet for withdrawing a bottom stream comprising C3-C4 paraffins and C5+ hydrocarbons;
   an LPG splitter, suitably a fractionation column, comprising an inlet for receiving said bottom stream from the LPG splitter, an outlet for withdrawing an overhead stream comprising C3-C4 paraffins, and an outlet for withdrawing a bottom stream as the gasoline product;
wherein the plant further comprises:
   an upgrading reactor comprising a catalyst, such as a fixed bed of catalyst, active in converting the C3-C4 paraffins into an aromatic stream comprising any of benzene, toluene and xylene (BTX), or combinations thereof, such as an aromatic stream comprising benzene, toluene and xylene, an inlet for receiving the entire or a portion of said overhead stream from the LPG splitter, and an outlet for withdrawing said aromatic stream; said upgrading reactor being absent of, i.e. without, an inlet for co-feeding an oxygenate stream such as conduit directing a stream comprising methanol and/or dimethyl ether (DME); and
   a conduit for directing the entire aromatic stream or a portion thereof to said oxygenate feed stream, suitably to a mixing point which is upstream said mixing point where the overhead recycle stream of the MTG section is combined with the oxygenate feed stream.

Suitably, one or more separators, e.g. fractionation column(s), are provided downstream the upgrading reactor for separating a benzene-rich (B-rich) stream, in particular from the most downstream separator, as said portion of the aromatic stream.

Suitably also, a stream rich in toluene and optionally xylene (T/X-rich stream) is withdrawing from the one or more separators, in particular from the most downstream separator, and a conduit is provided for combining the T/X-rich stream with the raw gasoline stream withdrawn from the product separator of the MTG section.

Suitably, a stream rich in paraffins, isoparaffins and olefins, i.e. a P/I/O-rich stream, is withdrawn from the one or more separators, in particular from the separator arranged immediately downstream the upgrading reactor, and a conduit is provided for combining the P/I/O-rich stream with the raw gasoline stream withdrawn from the product separator of the MTG section.

Suitably also, as in connection with the first aspect of the invention, the upgrading reactor is an electrically heated reactor (e-reactor); optionally operated adiabatically and optionally also, operated in once-through mode. For details reference is directed to earlier passages of the Description in accordance with the first aspect of the invention.

It would also be understood, that any of the embodiments of the first aspect of the invention (process) and associated benefits may be used in connection with the second aspect of the invention (plant), or vice versa.

### BRIEF DESCRIPTION OF THE FIGURES

The sole accompanying FIGURE shows a process and/or plant layout including the MTG section and downstream distillation section, the latter incorporating an upgrading reactor in accordance with an embodiment of the present invention.

### DETAILED DESCRIPTION

With reference to FIGURE, a process/plant 10 comprising a MTG section (MTG loop) I and distillation section II, according to the division depicted by the stippled line in the FIGURE. An oxygenate stream, e.g. e-methanol stream 1, is preheated in feed-effluent heat exchanger 30 and combined with preheated overhead recycle stream 3″, thereby forming oxygenate feed stream 5. The oxygenate feed stream 1, prior to any mixing with a recycle stream, more specifically the preheated recycle stream 3″ in the MTG loop, is combined, e.g. co-fed, with a benzene-rich stream (B-rich stream) 7 generated from downstream separator 80. The MTG reactor 35 has arranged therein a fixed bed of catalyst 35′ active for converting oxygenates in the oxygenate feed stream to a raw gasoline stream comprising C3-C4 paraffins and C5+ hydrocarbons. The effluent stream 9 from the MTG reactor 35 comprises therefore C3-C4 paraffins and C5+ hydrocarbons and is cooled by delivering heat in the feed-effluent heat exchanger 30. The cooled effluent stream 9′ is further cooled in cooling section 40, for instance by supplying heat in an additional heat exchanger (not shown) used for preheating overhead recycle stream 3′ from recycle compressor 45, as well as by passing through an optional air cooler (not shown) and heat exchanger using cooling water as heat exchanging medium (not shown). The thus cooled effluent stream 9″ is conducted to a product separator 50, e.g. a high pressure separator, thereby forming water stream 11, raw gasoline stream 13 as well as overhead recycle stream 3 from which a fuel gas stream 3′″ may be derived.

The raw gasoline stream 13 from the MTG loop I enters the distillation section II by combining it with a stream rich in toluene and optionally xylene (T/X-rich stream 17) as well as a stream rich in paraffins, isoparaffins and olefins (P/I/O-rich stream 19), which are separated from an aromatic stream comprising benzene, toluene and xylene (BTX) in downstream upgrading reactor 70 as explained farther below.

The raw gasoline stream 13′, now mixed with the T/X-rich stream 17 and P/I/O-rich stream 19, enters a de-ethanizer 55 suitably in the form of a fractionating column, thereby separating a fuel gas stream 21 comprising C2-compounds and optionally also a sulfur compound, e.g. H₂S. The bottom stream 23 of the de-ethanizer 55, now containing mainly C3-C4 paraffins e.g. LPG and C5+ hydrocarbons, is conducted to LPG splitter 60 suitably in the form of a fractionating column, for thereby finally separating from the raw gasoline stream 13 a bottom stream 25 as the gasoline product stream comprising the C5+ hydrocarbons and an overhead stream 27 comprising C3-C4 paraffins, e.g. LPG. The gasoline product stream 25 may be optionally further refined by conducting it to a gasoline splitting column and HDI unit (not shown) for thereby further increasing the octane number of the gasoline product, thus resulting in an upgraded gasoline product.

The overhead stream 27 comprising C3-C4 paraffins, e.g. LPG, is conducted to an upgrading reactor 70 under the presence of a catalyst 70′ active for converting the C3-C4 paraffins into an aromatic stream 29 comprising benzene, toluene and xylene (BTX). Suitably, a feed-effluent heat exchanger (not shown) is also provided for preheating stream 27. The upgrading reactor is an electrically heated reactor (e-reactor) using power 70″ generated from a renewable source such as wind or solar energy. A sulfur compound such as H₂S is suitably added as stream 15 to the upgrading reactor 70. There is no co-feeding of an oxygenate stream to the upgrading reactor 70.

The aromatic stream comprising BTX 29 is conducted to a downstream separator 75, suitably in the form of a fractionating column, for thereby forming the P/I/O-rich stream 19 which is withdrawn and combined with the raw gasoline product 13 from the MTG loop. A stream 31 comprising mainly BTX is also withdrawn and conducted to a second separator 80, suitably in the form of a fractionating column, for thereby forming the T/X-rich stream 17 which is withdrawn and combined with the raw gasoline 13, as well as the B-rich stream 7 which is combined with oxygenate feed stream 1 in the MTG reactor 35.

### Example

The operation of a process plant in accordance with the appended FIGURE (invention)—where the upgrading reactor produces 7800 kg/h BTX, yet where there is direct addition of a BTX rich stream to the MTG reactor (i.e. no separation of benzene)—, is compared with operation where the difference is that there is no upgrading reactor and no addition of a BTX rich stream to the MTG reactor. The former is denoted as “Embodiment of invention”, while the latter is denoted “Prior art embodiment”. The table below shows the results:

TABLE

| | Prior art | Embodiment of |
|---|---|---|
| | embodiment | invention |
| C5+ yield (kg/h) | 77453 | 85253 |
| Yield increase (%) | — | 10.1 |
| Aromatics in C5+ (wt %) | 35.0 | 40.9 |
| Benzene in C5+ (wt %) | 0.85 | 0.97 |
| Increase in RON | — | >1 |

1. A process for producing a gasoline product from an oxygenate feed stream, the process comprising:
i) conducting the oxygenate feed stream to an oxygenate-to-gasoline reactor, under the presence of a fixed bed of catalyst active for converting oxygenates in the oxygenate feed stream to a raw gasoline stream comprising C3-C4 paraffins and C5+ hydrocarbons;
ii) separating from the raw gasoline stream a gasoline product stream comprising the C5+ hydrocarbons and a stream comprising C3-C4 paraffins;
iii) conducting the entire stream comprising C3-C4 paraffins or a portion thereof to an upgrading reactor under the presence of a catalyst active for converting the C3-C4 paraffins into an aromatic stream comprising any of benzene, toluene or xylene, or combinations thereof;
iv) combining the entire aromatic stream or a portion thereof with the oxygenate feed stream;
wherein step iii) does not comprise co-feeding an oxygenate stream to the upgrading reactor.

2. The process according to claim 1, wherein in step iv) the portion of the aromatic stream is a benzene-rich stream (B-rich stream) which is separated from the aromatic stream.

3. The process according to claim 1, wherein the catalyst in the MTG reactor is a zeolitic catalyst having an MFI framework; and wherein the temperature in the MTG reactor is 280-400° C., the pressure is in the range 15-25 bar abs; and optionally the WHSV is 1-6.

4. The process according to claim 1, wherein the oxygenate feed stream is methanol and/or dimethyl ether (DME).

5. The process according to claim 1, wherein in step iii) the process further comprises adding one or more sulfur compounds to the stream comprising C3-C4 paraffins, and wherein the content of the one or more sulfur compounds, is 10-1000 ppmv.

6. The process according to claim 1, wherein the raw gasoline stream comprises C2− compounds and the process further comprises: prior to step ii), conducting the raw gasoline stream to a de-ethanizer for generating a fuel gas stream comprising the C2 compounds and optionally a sulfur compound.

7. The process according to claim 6, wherein the gasoline product stream comprising the C5+ hydrocarbons is conducted to a hydroisomerization (HDI) step, optionally after being conducted to a fractionation step; the fuel gas stream comprising the C2− compounds comprises a sulfur compound; and the fuel gas stream is added to the HDI step, suitably by admixing with the gasoline product stream prior to entering the HDI step.

8. The process according to claim 1, wherein a stream rich in toluene and optionally xylene (T/X-rich stream,) as well as a stream rich in paraffins, isoparaffins and olefins (P/I/O-rich stream) optionally also comprising unconverted LPG lower hydrocarbons and C5+ hydrocarbons, are separated from the aromatic stream comprising BTX, and:
at least one of the T/X-rich stream or a portion thereof and the P/I/O-rich stream or a portion thereof, is added to the raw gasoline stream, suitably prior to conducting the raw gasoline stream to the de-ethanizer; and/or
the P/I/O-rich stream or a portion thereof is added to the MTG reactor.

9. The process according to claim 1, wherein the catalyst in the upgrading reactor is a zeolitic catalyst having an MFI framework containing 0.1 to 10 percent by weight of a zinc compound.

10. The process according to claim 9, wherein the zeolitic catalyst is ZSM-5, the zinc compound is metallic and/or oxidic zinc, and optionally the zeolitic catalyst further comprises 1-5 wt % of a phosphorous compound.

11. The process according to claim 1, wherein the temperature in the upgrading reactor is 500-650° C., and the pressure is in the range 3-25 bar abs.

12. The process according to claim 1, wherein the upgrading reactor is an electrically heated reactor (e-reactor); optionally operated adiabatically and optionally also, operated in once-through mode.

13. The process according to claim 1, further comprising, prior to step iv), conducting the aromatic stream to a buffer tank.

14. A plant for producing a gasoline product from an oxygenate feed stream, comprising: a methanol-to-gasoline (MTG) section and a downstream distillation section;
wherein said MTG section (I) comprises: a MTG reactor comprising a fixed bed of catalyst, a product separator and a recycle compressor, thereby converting the oxygenate feed stream to a raw gasoline stream comprising C3-C4 paraffins and C5+ hydrocarbons;
wherein said distillation section (II) comprises: a de-ethanizer and a LPG-splitter, thereby converting the raw gasoline stream to said gasoline product, and a stream comprising C3-C4 paraffins;
wherein said plant further comprises:
an upgrading reactor comprising a catalyst, thereby converting the entire stream comprising C3-C4 paraffins or a portion thereof, to an aromatic stream comprising any of benzene, toluene and xylene (BTX), or combinations thereof; said upgrading reactor being absent of an inlet for co-feeding an oxygenate stream;
a conduit for directing the entire aromatic stream or a portion thereof to said oxygenate feed stream.
